(19) United States
(12) Patent Application Publication
(10) Pub. No.: US 2019/0183609 A1
(43) Pub. Date: Jun. 20, 2019

(54) Dental Form Assembly

(71) Applicant: Johnny Yonnadam, Hamilton (CA)

(72) Inventor: Johnny Yonnadam, Hamilton (CA)

(21) Appl. No.: 15/848,203

(22) Filed: Dec. 20, 2017

(51) Int. Cl. A61C 5/85

(52) U.S. Cl. CPC A61C 5/85

(57) ABSTRACT

A dental form assembly for forming a restorative material in a pair of adjacent teeth during a dental procedure includes a first band that is selectively wrapped around a first tooth thereby facilitating the first band to be aligned with a cavity in the first tooth. The first band is comprised of a metallic material to retain a restorative material in the cavity. A second band is coupled to the first band and the second band is selectively wrapped around a second tooth is adjacent to the first tooth. Additionally, the second band is aligned with a cavity in the second tooth. Each of the first band and the second band facilitate the cavity in each of the first tooth and the second tooth to be simultaneously filled. The second band is comprised of a metallic material to retain the restorative material in the cavity in the second tooth.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to form devices and more particularly pertains to a new form device for forming a restorative material in a pair of adjacent teeth in a dental procedure.

### BRIEF SUMMARY OF THE INVENTION

An embodiment of the disclosure meets the needs presented above by generally comprising a first band that is selectively wrapped around a first tooth thereby facilitating the first band to be aligned with a cavity in the first tooth. The first band is comprised of a metallic material to retain a restorative material in the cavity. A second band is coupled to the first band and the second band is selectively wrapped around a second tooth is adjacent to the first tooth. Additionally, the second band is aligned with a cavity in the second tooth. Each of the first band and the second band facilitate the cavity in each of the first tooth and the second tooth to be simultaneously filled. The second band is comprised of a metallic material to retain the restorative material in the cavity in the second tooth.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a dental form assembly according to an embodiment of the disclosure.

FIG. 2 is a top view of an embodiment of the disclosure.

FIG. 3 is a front view of an embodiment of the disclosure.

FIG. 4 is a front in-use view of an embodiment of the disclosure.

FIG. 5 is a perspective in-use view of an embodiment of the disclosure.

### DETAILED DESCRIPTION OF THE INVENTION

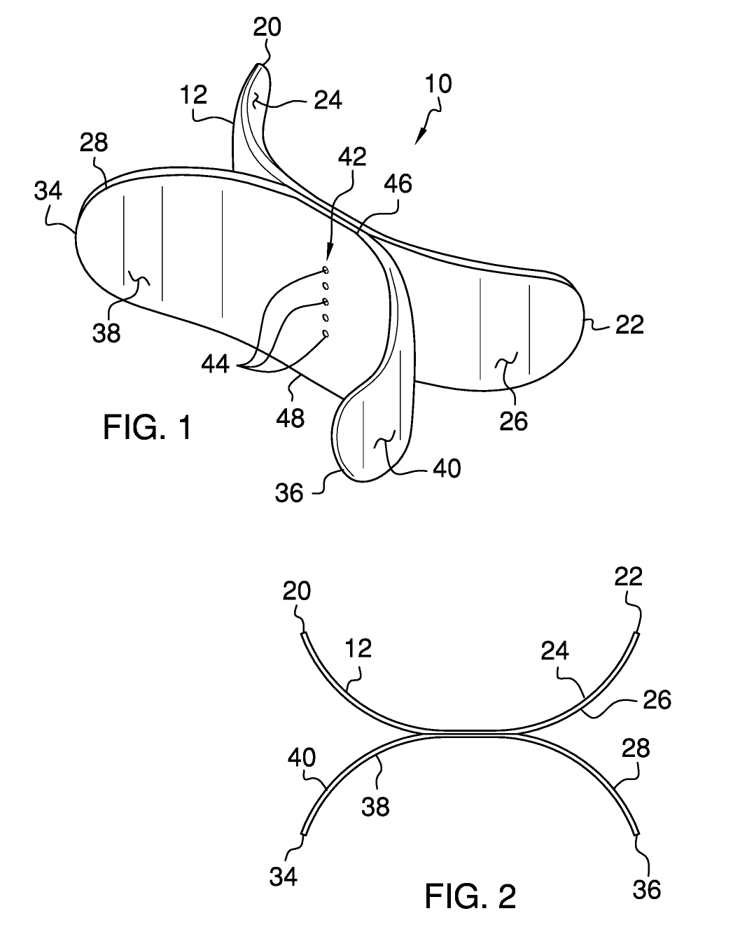

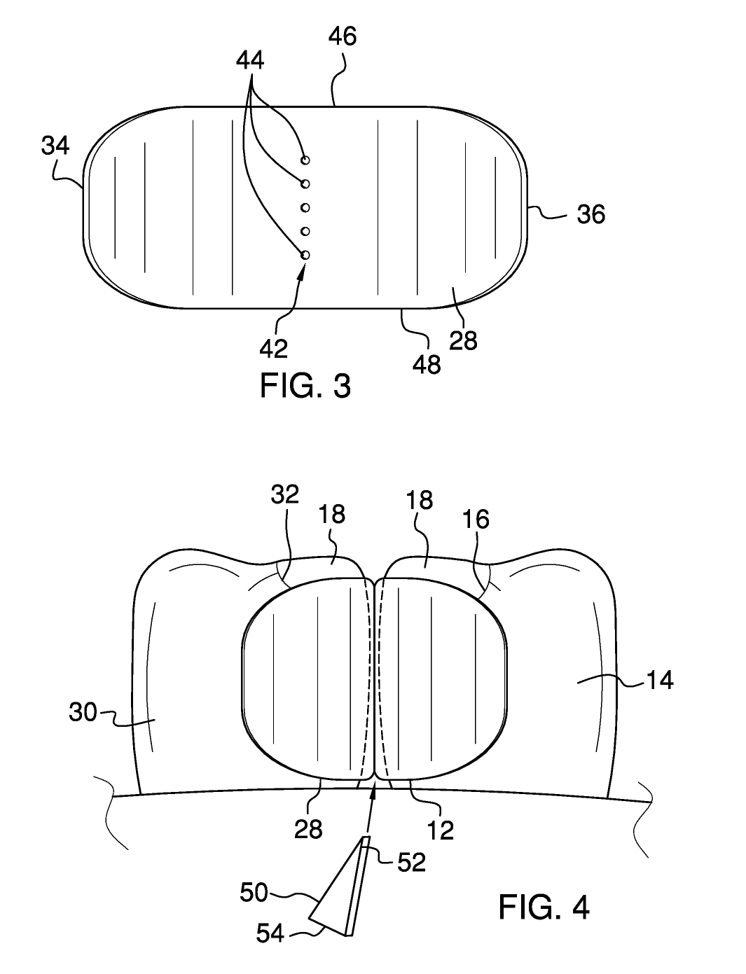

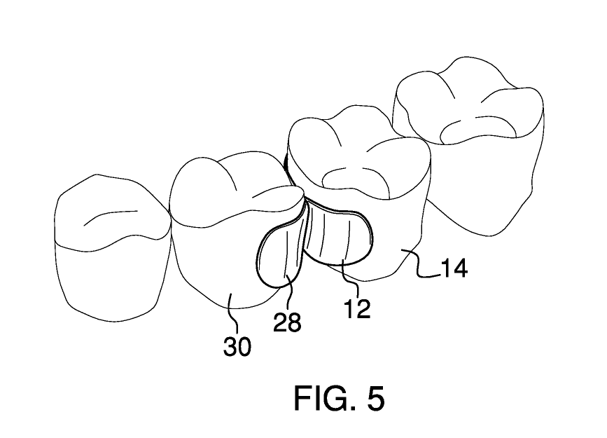

With reference now to the drawings, and in particular to FIGS. 1 through 5 thereof, a new form device embodying the principles and concepts of an embodiment of the disclosure and generally designated by the reference numeral 10 will be described.

As best illustrated in FIGS. 1 through 5, the dental form assembly 10 generally comprises a first band 12 that is selectively be wrapped around a first tooth 14 thereby facilitating the first band 12 to be aligned with a cavity 16 in the first tooth 14. The first band 12 is comprised of a metallic material such as stainless steel or the like. Thus, the first band 12 may retain a restorative material 18 in the cavity 16. The restorative material 18 may be any dental filling material such as gold, ceramic and any other material used in the dental industry for filling and restoring teeth.

The first band 12 has a first end 20, a second end 22, a first surface 24 and a second surface 26. The first band 12 is elongated between the first end 20 and the second end 22 and each of the first end 20 and the second end 22 is rounded. The first surface 24 abuts the first tooth 14 when the first band 12 is wrapped around the tooth. The first band 12 may have a length ranging between approximately 12.0 mm and 40.0 mm.

A second band 28 is provided and the second band 28 is coupled to the first band 12. The second band 28 is wrapped around a second tooth 30 that is adjacent to the first tooth 14. Moreover, the second band 28 is aligned with a cavity 32 in the second tooth 30. Each of the first band 12 and the second band 28 facilitate the cavity 16,32 in each of the first tooth 14 and the second tooth 30 to be simultaneously filled. In this way the cavity 16,32 in the adjacent teeth may be filled without having to move a band from one tooth to the other for shaping the restorative material 18. The second band 28 is comprised of a metallic material such as stainless steel or the like. Thus, the second band 28 retains the restorative material 18 in the cavity in the second tooth 30. The second band 28 may have a length ranging between approximately 12.0 mm and 40.0 mm.

The second band 28 has a primary end 34, a secondary end 36, a primary surface 38 and a secondary surface 40 and each of the primary end 34 and the secondary end 36 are rounded. The secondary surface 40 is bonded to the second surface 26 of the first band 12 to define a bonding point 42 on each of the first band 12 and the second band 28. The bonding point 42 is centrally positioned on each of the first band 12 and the second band 28. The second band 28 is oriented collinear with the first band 12 such that the primary end 34 is aligned with the first end 20 and the secondary end 36 is aligned with the second end 22. The bonding point 42 comprises a plurality of welds 44. The welds 44 are spaced apart from each other and are distributed between a top edge 46 and a bottom edge 48 corresponding to each of the first band 12 and the second band 28. The primary surface 38 of the second band 28 abuts the second tooth 30 when the second band 28 is wrapped around the second tooth 30.

A wedge 50 is provided with a first end 52 and a second end 54 and the wedge 50 tapers to an edge between the first end 52 and the second end 54. Additionally, the wedge is selectively inserted between the first band 12 and the second band 28 along the bottom edge 48 when the first band 12 and the second band 28 are positioned between the first tooth 14 and the second tooth 30. Thus, the wedge 50 compresses the first band 12 against the first tooth 14 and the wedge 50 compresses the second band 28 against the second tooth 30. In this way the wedge 50 inhibits the restorative material from spilling outwardly from the first band 14 and the second band 28 when the first tooth 14 is excessively spaced from the second tooth 30.

In use, each of the first band 12 and the second band 28 are positioned between the first tooth 14 and the second tooth 30. Additionally, the bonding point 42 is positioned between the first tooth 14 and the second tooth 30. The first band 12 is wrapped around the first tooth 14 and the second band 28 is wrapped around the second tooth 30. Additionally, each of the first band 12 and the second band 28 are aligned with the cavity in the associated first tooth 14 and second tooth 30. The restorative material 18 is packed into the cavity in each of the first tooth 14 and the second tooth 30. The first band 12 and the second band 28 serve to form the restorative material 18 in the cavity and to retain the restorative material 18 in the cavity. Moreover, the first band 12 and the second band 28 facilitate a pair of adjacent teeth to be simultaneously filled thereby enhancing efficiency with respect to using a single band for restoring a cavity. A wedge or the like may be positioned beneath and between the first band 12 and the second band 28 to inhibit the restorative material 18 from flowing beneath the first band 12 and the second band 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A dental form assembly being configured to be positioned around an adjacent pair of teeth for forming a restorative filling, said assembly comprising:
a first band being configured to be wrapped around a first tooth thereby facilitating said first band to be aligned with a cavity in the first tooth, said first band being comprised of a metallic material wherein said first band is configured to retain a restorative material in the cavity, said first band having a first end, a second end, a first surface and a second surface, said first band being elongated between said first end and said second end, said first band having a top edge and a bottom edge, said first surface being arcuate extending between said first end and said second end, said first surface being straight extending an entire length from said top edge to said bottom edge; and
a second band being coupled to said first band, said second band being configured to be wrapped around a second tooth being adjacent to the first tooth thereby facilitating said second band to be aligned with a cavity in the second tooth, each of said first band and said second band being configured to facilitate the cavity in each of said first tooth and said second tooth to be simultaneously filled, said second band being comprised of a metallic material wherein said second band is configured to retain the restorative material in the cavity in the second tooth.

2. The assembly according to claim 1, wherein each of said first end and said second end being rounded, said first surface being configured to abut the first tooth when said first band is wrapped around the tooth.

3. The assembly according to claim 1, wherein:
said second band has a primary end, a secondary end, a primary surface and a secondary surface, said secondary surface being bonded to said second surface of said first band to define a bonding point being centrally positioned on each of said first band and said second band.

4. The assembly according to claim 3, wherein said second band is oriented collinear with said first band such that said primary end is aligned with said first end and said secondary end is aligned with said second end, said bonding point comprising a plurality of welds, said primary surface being configured to abut the second tooth when said second band is wrapped around the second tooth.

5. A dental form assembly being configured to be positioned around an adjacent pair of teeth for forming a restorative filling, said assembly comprising:
a first band being configured to be wrapped around a first tooth thereby facilitating said first band to be aligned with a cavity in the first tooth, said first band being comprised of a metallic material wherein said first band is configured to retain a restorative material in the cavity, said first band having a first end, a second end, a first surface and a second surface, said first band being elongated between said first end and said second end, each of said first end and said second end being rounded, said first surface being configured to abut the first tooth when said first band is wrapped around the tooth, said first band having a top edge and a bottom edge, said first surface being arcuate extending between said first end and said second end, said first surface being straight extending an entire length from said top edge to said bottom edge; and
a second band being coupled to said first band, said second band being configured to be wrapped around a second tooth being adjacent to the first tooth thereby facilitating said second band to be aligned with a cavity in the second tooth, each of said first band and said second band being configured to facilitate the cavity in each of said first tooth and said second tooth to be simultaneously filled, said second band being comprised of a metallic material wherein said second band is configured to retain the restorative material in the cavity in the second tooth, said second band having a primary end, a secondary end, a primary surface and a secondary surface, said secondary surface being bonded to said second surface of said first band to define a bonding point being centrally positioned on each of said first band and said second band, said second band being oriented collinear with said first band such that said primary end is aligned with said first end and said secondary end is aligned with said second end, said bonding point comprising a plurality of welds, said primary surface being configured to abut the second tooth when said second band is wrapped around the second tooth.
